(19) United States
(12) Patent Application Publication
(10) Pub. No.: US 2015/0305359 A1
(43) Pub. Date: Oct. 29, 2015

(54) NUTRITIONAL COMPOSITIONS DIRECTED TO SUBJECTS HAVING COW'S MILK PROTEIN ALLERGIES

(71) Applicant: Mead Johnson Nutrition Company, Glenview, IL (US)

(72) Inventors: Zihua Ao, Newburgh, IN (US); Juan M. Gonzalez, Newburgh, IN (US)

(21) Appl. No.: 14/260,392

(22) Filed: Apr. 24, 2014

(51) Int. Cl. A23C 11/10

(52) U.S. Cl. CPC A23C 11/106; A23Y 2220/73

(57) ABSTRACT

A method for supporting and promoting nutrition in a pediatric subject having allergies to cow's milk, the method involving administering to the pediatric subject a nutritional composition which includes up to about 7 g/100 kcal of a source of non-dairy proteins; about 1×10⁴ to about 1.5×10¹² cfu of probiotic(s) per 100 kcal; about 5 g and about 25 g/100 kcal of a carbohydrate source; up to about 7 g/100 kcal of a fat or lipid source; and at least about 5 mg/100 kcal of a long chain polyunsaturated fatty acid.

### TECHNICAL FIELD

The present disclosure relates generally to a nutritional composition that is suitable for administration to pediatric subjects having cow's milk protein allergies or a propensity for cow's milk protein allergies. More particularly, the disclosure relates to methods of supporting and promoting nutrition in a pediatric subject having allergies to cow's milk and/or a propensity for such allergies, via administration of the nutritional composition of the present disclosure. In some embodiments, the nutritional composition comprises non-dairy proteins as well as a probiotic such as Lactobacillus rhamnosus GG (“LGG”); the composition of the present disclosure can also include a fat or lipid, such as certain classes of polar lipids, a prebiotic blend which includes polydextrose and galacto-oligosaccharides, and a source of long chain polyunsaturated fatty acids, wherein the foregoing components may exhibit additive and/or synergistic beneficial effects.

### BACKGROUND ART

Food allergies, such as allergy to cow's milk protein, soy protein, rice protein and peanuts, is being recognized as an increasing problem. Cow's milk protein allergy (“CMA”) is the most common food allergy in early childhood and affects 2-3% of young children with a range of immunoglobulin (Ig-E) and non Ig-E mediated syndromes. Food allergies continue to be a growing health concern with an increasing prevalence and severity, potential increase of atopic disease in later life, risk of persistence, and functional gastrointestinal disorders. Thus, there is a strong need to develop effective therapies.

The first step of treatment of CMA is the rapid resolution of symptoms, with elimination of cow's milk protein from the diet the only proven treatment. For infants less than 1 year of age, extensively hydrolyzed protein (casein or whey) based formulas are conventionally recommended to address CMA. Other formulas, such as soy protein based or amino acid based formula, are indicated for infants or children who also show extreme sensitivity to cow's milk protein.

### BRIEF SUMMARY

Briefly, the present disclosure is directed, in an embodiment, to a method and composition for managing the symptoms of food allergies such as CMA, and reducing the time of tolerance acquisition for such allergies, in a pediatric subject. The method comprises administering to the pediatric subject a nutritional composition comprising non-dairy proteins as well as a probiotic such as Lactobacillus rhamnosus GG (“LGG”). The composition can also include a fat or lipid, such as certain classes of polar lipids, a prebiotic blend which includes polydextrose and galacto-oligosaccharides, and a source of long chain polyunsaturated fatty acids. In certain embodiments, the method comprises administering a nutritional composition comprising:

a. up to about 7 g/100 kcal of a protein source, more preferably about 1 g/100 kcal to about 5 g/100 kcal of a protein source, wherein the protein source consists essentially of one or more non-dairy proteins;

b. about 1×10⁴ to about 1.5×10¹² cfu of probiotic(s) per 100 kcal. In some embodiments the amount of probiotic may be from about 1×10⁶ to about 1×10⁹ cfu of probiotic(s) per 100 kcal, more preferably from about 1×10⁷ cfu/100 kcal to about 1×10⁸ cfu of probiotic(s) per 100 kcal. In certain embodiments, the probiotic comprises LGG;

c. up to about 7 g/100 kcal of a fat or lipid source, more preferably about 3 g/100 kcal to about 7 g/100 kcal of a fat or lipid source;

d. about 0.1 g/100 kcal to about 1 g/100 kcal of a prebiotic composition comprising PDX and GOS; and

e. at least about 5 mg/100 kcal of an LCPUFA comprising docosahexaenoic acid (DHA), more preferably from about 5 mg/100 kcal to about 75 mg/100 kcal of LCPUFAs comprising DHA.

In other embodiments, the disclosure is directed to methods for managing the symptoms of a food allergy and reducing the time for tolerance acquisition in a pediatric subject by administering to the subject a nutritional composition comprising non-dairy proteins and a probiotic.

It is to be understood that both the foregoing general description and the following detailed description present embodiments of the disclosure and are intended to provide an overview or framework for understanding the nature and character of the disclosure as it is claimed. The description serves to explain the principles and operations of the claimed subject matter. Other and further features and advantages of the present disclosure will be readily apparent to those skilled in the art upon a reading of the following disclosure.

### DETAILED DESCRIPTION

Reference now will be made in detail to the embodiments of the present disclosure, one or more examples of which are set forth hereinbelow. Each example is provided by way of explanation of the nutritional composition of the present disclosure and is not a limitation. In fact, it will be apparent to those skilled in the art that various modifications and variations can be made to the teachings of the present disclosure without departing from the scope of the disclosure. For instance, features illustrated or described as part of one embodiment, can be used with another embodiment to yield a still further embodiment.

Thus, it is intended that the present disclosure covers such modifications and variations as come within the scope of the appended claims and their equivalents. Other objects, features and aspects of the present disclosure are disclosed in or are obvious from the following detailed description. It is to be understood by one of ordinary skill in the art that the present discussion is a description of exemplary embodiments only and is not intended as limiting the broader aspects of the present disclosure.

The present disclosure relates generally to nutritional compositions that are suitable for administration to a pediatric subject. Additionally, the disclosure relates to methods of managing the symptoms of food allergies and reducing the time to tolerance acquisition in a pediatric subject via administration of nutritional compositions.

“Allergy” as used herein is defined as an “abnormal hypersensitivity to a substance which is normally tolerated and generally considered harmless.” There are two basic phases involved with the allergic response. The first stage involves the development of the early phase of an immediate-type hypersensitivity response to allergens. The first time an allergen meets the immune system, no allergic reaction occurs. Instead, the immune system prepares itself for future encounters with the allergen. Macrophages, which are scavenger cells, surround and break up the invading allergen. The macrophages then display the allergen fragments on their cell walls to T lymphocytes, which are the main orchestraters of the body's immune reaction. This cognitive signal plus several non-cognitive signals (e.g. cytokines) activate the naïve T-cells and instruct the T-cell differentiation into T-cell effector subpopulations. The key players in the allergic cascade are T-cells of the Th-2 phenotype (TH-2). TH-2 type T-cells are characterized by the secretion of several cytokines including interleukin-4 (IL-4), IL-5 and IL-13. The cytokines IL-4 and IL-13 then activate B lymphocytes which produce antibodies of the subclass E (IgE). IgE antibodies are directed against the particular allergen. The interaction of specific IgE antibodies on the surface of effector cells (mast cells and basophils) with an allergen triggers the early phase of immediate type hypersensitivity responses.

This mast cell activation usually occurs within minutes after the second exposure to an allergen. IgE antibodies on mast cells, constructed during the sensitization phase, recognize the allergen and bind to the invader. Once the allergen is bound to the receptor, granules in the mast cells release their contents. These contents, or mediators, are proinflammatory substances such as histamine, platelet-activating factor, prostaglandins, cytokines and leukotrienes. These mediators actually trigger the allergy attack. Histamine stimulates mucus production and causes redness, swelling, and inflammation. Prostaglandins constrict airways and enlarge blood vessels.

The second phase of the allergic immune response is characterized by infiltration of inflammatory cells, such as eosinophils, into the airways after an allergen exposure. An important linkage between sensitization and inflammation is represented by T-cells that secrete mediators not only involved in IgE synthesis, but also responsible for eosinophil recruitment, activation and survival. The tissue mast cells and neighboring cells produce chemical messengers that signal circulating basophils, eosinophils, and other cells to migrate into that tissue and help fight the foreign material. Eosinophils secrete chemicals of their own that sustain inflammation, cause tissue damage, and recruit yet more immune cells. This phase can occur anywhere between several hours and several days after the allergen exposure and can last for hours and even days.

“Nutritional composition” means a substance or formulation that satisfies at least a portion of a subject's nutrient requirements. The terms “nutritional(s)”, “nutritional formula(s)”, “enteral nutritional(s)”, and “nutritional supplement(s)” are used as non-limiting examples of nutritional composition(s) throughout the present disclosure. Moreover, “nutritional composition(s)” may refer to liquids, powders, gels, pastes, solids, concentrates, suspensions, or ready-to-use forms of enteral formulas, oral formulas, formulas for infants, formulas for pediatric subjects, formulas for children, growing-up milks and/or formulas for adults.

The term “enteral” means deliverable through or within the gastrointestinal, or digestive, tract. “Enteral administration” includes oral feeding, intragastric feeding, transpyloric administration, or any other administration into the digestive tract. “Administration” is broader than “enteral administration” and includes parenteral administration or any other route of administration by which a substance is taken into a subject's body.

“Pediatric subject” means a human no greater than 13 years of age. In some embodiments, a pediatric subject refers to a human subject that is between birth and 8 years old. In other embodiments, a pediatric subject refers to a human subject between 1 and 6 years of age. In still further embodiments, a pediatric subject refers to a human subject between 6 and 12 years of age. The term “pediatric subject” may refer to infants (preterm or full term) and/or children, as described below.

“Infant” means a human subject ranging in age from birth to not more than one year and includes infants from 0 to 12 months corrected age. The phrase “corrected age” means an infant's chronological age minus the amount of time that the infant was born premature. Therefore, the corrected age is the age of the infant if it had been carried to full term. The term infant includes low birth weight infants, very low birth weight infants, extremely low birth weight infants and preterm infants. “Preterm” means an infant born before the end of the 37^{th} week of gestation. “Late preterm” means an infant form between the 34^{th} week and the 36^{th} week of gestation. “Full term” means an infant born after the end of the 37^{th} week of gestation. “Low birth weight infant” means an infant born weighing less than 2500 grams (approximately 5 lbs, 8 ounces). “Very low birth weight infant” means an infant born weighing less than 1500 grams (approximately 3 lbs, 4 ounces). “Extremely low birth weight infant” means an infant born weighing less than 1000 grams (approximately 2 lbs, 3 ounces).

“Child” means a subject ranging in age from 12 months to 13 years. In some embodiments, a child is a subject between the ages of 1 and 12 years old. In other embodiments, the terms “children” or “child” refer to subjects that are between one and about six years old, or between about seven and about 12 years old. In other embodiments, the terms “children” or “child” refer to any range of ages between 12 months and about 13 years.

“Children's nutritional product” refers to a composition that satisfies at least a portion of the nutrient requirements of a child. A growing-up milk is an example of a children's nutritional product.

The term “degree of hydrolysis” refers to the extent to which peptide bonds are broken by a hydrolysis method.

The term “partially hydrolyzed” means having a degree of hydrolysis which is greater than 0% but less than about 50%.

The term “extensively hydrolyzed” means having a degree of hydrolysis which is greater than or equal to about 50%.

The term “protein-free” means containing no measurable amount of protein, as measured by standard protein detection methods such as sodium dodecyl(lauryl)sulfate-polyacrylamide gel electrophoresis (SDS-PAGE) or size exclusion chromatography. In some embodiments, the nutritional composition is substantially free of protein, wherein “substantially free” is defined hereinbelow.

“Infant formula” means a composition that satisfies at least a portion of the nutrient requirements of an infant. In the United States, the content of an infant formula is dictated by the federal regulations set forth at 21 C.F.R. Sections 100, 106, and 107. These regulations define macronutrient, vitamin, mineral, and other ingredient levels in an effort to simulate the nutritional and other properties of human breast milk.

The term “growing-up milk” refers to a broad category of nutritional compositions intended to be used as a part of a diverse diet in order to support the normal growth and development of a child between the ages of about 1 and about 6 years of age.

“Nutritionally complete” means a composition that may be used as the sole source of nutrition, which would supply essentially all of the required daily amounts of vitamins, minerals, and/or trace elements in combination with proteins, carbohydrates, and lipids. Indeed, “nutritionally complete” describes a nutritional composition that provides adequate amounts of carbohydrates, lipids, essential fatty acids, proteins, essential amino acids, conditionally essential amino acids, vitamins, minerals and energy required to support normal growth and development of a subject.

Therefore, a nutritional composition that is “nutritionally complete” for a preterm infant will, by definition, provide qualitatively and quantitatively adequate amounts of carbohydrates, lipids, essential fatty acids, proteins, essential amino acids, conditionally essential amino acids, vitamins, minerals, and energy required for growth of the preterm infant.

A nutritional composition that is “nutritionally complete” for a full term infant will, by definition, provide qualitatively and quantitatively adequate amounts of all carbohydrates, lipids, essential fatty acids, proteins, essential amino acids, conditionally essential amino acids, vitamins, minerals, and energy required for growth of the full term infant.

A nutritional composition that is “nutritionally complete” for a child will, by definition, provide qualitatively and quantitatively adequate amounts of all carbohydrates, lipids, essential fatty acids, proteins, essential amino acids, conditionally essential amino acids, vitamins, minerals, and energy required for growth of a child.

As applied to nutrients, the term “essential” refers to any nutrient that cannot be synthesized by the body in amounts sufficient for normal growth and to maintain health and that, therefore, must be supplied by the diet. The term “conditionally essential” as applied to nutrients means that the nutrient must be supplied by the diet under conditions when adequate amounts of the precursor compound is unavailable to the body for endogenous synthesis to occur.

“Probiotic” means a microorganism with low or no pathogenicity that exerts a beneficial effect on the health of the host.

The term “non-viable probiotic” means a probiotic wherein the metabolic activity or reproductive ability of the referenced probiotic has been reduced or destroyed. More specifically, “non-viable” or “non-viable probiotic” means non-living probiotic microorganisms, their cellular components and/or metabolites thereof. Such non-viable probiotics may have been heat-killed or otherwise inactivated. The “non-viable probiotic” does, however, still retain, at the cellular level, its cell structure or other structure associated with the cell, for example exopolysaccharide and at least a portion its biological glycol-protein and DNA/RNA structure and thus retains the ability to favorably influence the health of the host. Contrariwise, the term “viable” refers to live microorganisms. As used herein, the term “non-viable” is synonymous with “inactivated”.

“Prebiotic” means a non-digestible food ingredient that beneficially affects the host by selectively stimulating the growth and/or activity of one or a limited number of bacteria in the digestive tract that can improve the health of the host.

“Polar lipids” are the main constituents of natural membranes, occurring in all living organisms. The polar lipids in milk (i.e., milk polar lipids) are mainly situated in the milk fat globule membrane (MFGM). This is a highly complex biological membrane that surrounds the fat globule, hereby stabilizing it in the continuous phase of the milk. Polar lipids are also present in other sources than milk such as eggs, meat and plants.

Polar lipids are generally divided into phospholipids and sphingolipids (including gangliosides), which are amphiphilic molecules with a hydrophobic tail and a hydrophilic head group. The glycerophospholipids consist of a glycerol backbone on which two fatty acids are esterified on positions sn-1 and sn-2. These fatty acids are more unsaturated than the triglyceride fraction of milk. On the third hydroxyl, a phosphate residue with different organic groups (choline, serine, ethanolamine, etc.) may be linked. Generally, the fatty acid chain on the sn-1 position is more saturated compared with that at the sn-2 position. Lysophospholipids contain only one acyl group, predominantly situated at the sn-1 position. The head group remains similar. The characteristic structural unit of sphingolipids is the sphingoid base, a long-chain (12-22 carbon atoms) aliphatic amine containing two or three hydroxyl groups. Sphingosine (d18:1), is the most prevalent sphingoid base in mammalian sphingolipids, containing 18 carbon atoms, two hydroxyl groups and one double bond. A ceramide is formed when the amino group of this sphingoid base is linked with, usually, a saturated fatty acid. On this ceramide unit, an organophosphate group can be bound to form a sphingophospholipid (e.g., phosphocholine in the case of sphingomyelin) or a saccharide to form the sphingoglycolipids (glycosylceramides). Monoglycosylceramides, like glucosylceramide or galactosylceramide are often denoted as cerebrosides while tri- and tetraglycosylceramides with a terminal galactosamine residue are denoted as globosides. Finally, gangliosides are highly complex oligoglycosylceramides, containing one or more sialic acid groups in addition to glucose, galactose and galactosamine.

“β-glucan” means all β-glucan, including specific types of β-glucan, such as β-1,3-glucan or β-1,3;1,6-glucan. Moreover, β-1,3;1,6-glucan is a type of β-1,3-glucan. Therefore, the term “β-1,3-glucan” includes β-1,3;1,6-glucan.

As used herein, “lactoferrin from a non-human source” means lactoferrin which is produced by or obtained from a source other than human breast milk. For example, lactoferrin for use in the present disclosure includes human lactoferrin produced by a genetically modified organism as well as non-human lactoferrin. The term “organism”, as used herein, refers to any contiguous living system, such as animal, plant, fungus or microorganism. The term “non-human lactoferrin”, as used herein, refers to lactoferrin having an amino acid sequence that is different than the amino acid sequence of human lactoferrin.

As used herein, “non-human lactoferrin” means lactoferrin that has an amino acid sequence that is different than the amino acid sequence of human lactoferrin.

“Modulate” or “modulating” means exerting a modifying, controlling and/or regulating influence. In some embodiments, the term “modulating” means exhibiting an increasing or stimulatory effect on the level/amount of a particular component. In other embodiments, “modulating” means exhibiting a decreasing or inhibitory effect on the level/amount of a particular component.

All percentages, parts and ratios as used herein are by weight of the total formulation, unless otherwise specified.

All amounts specified as administered “per day” may be delivered in one unit dose, in a single serving or in two or more doses or servings administered over the course of a 24 hour period.

The nutritional composition of the present disclosure may be substantially free of any optional or selected ingredients described herein, provided that the remaining nutritional composition still contains all of the required ingredients or features described herein. In this context, and unless otherwise specified, the term “substantially free” means that the selected composition may contain less than a functional amount of the optional ingredient, typically less than 0.1% by weight, and also, including zero percent by weight of such optional or selected ingredient.

All references to singular characteristics or limitations of the present disclosure shall include the corresponding plural characteristic or limitation, and vice versa, unless otherwise specified or clearly implied to the contrary by the context in which the reference is made.

All combinations of method or process steps as used herein can be performed in any order, unless otherwise specified or clearly implied to the contrary by the context in which the referenced combination is made.

The methods and compositions of the present disclosure, including components thereof, can comprise, consist of, or consist essentially of the essential elements and limitations of the embodiments described herein, as well as any additional or optional ingredients, components or limitations described herein or otherwise useful in nutritional compositions.

As used herein, the term “about” should be construed to refer to both of the numbers specified as the endpoint(s) of any range. Any reference to a range should be considered as providing support for any subset within that range.

The present disclosure is directed to nutritional compositions comprising non-dairy proteins and at least one probiotic, to uses thereof, and to methods comprising administration of those nutritional compositions. The nutritional compositions of the present disclosure facilitate management of food allergy symptoms and reduce the time to tolerance acquisition in a pediatric human subject, such as an infant (preterm and/or term) or a child.

As noted above, the nutritional composition(s) of the disclosure may comprise at least one non-dairy protein source. The non-dairy protein source can be a plant protein, such as soy, pea, rice, potato, almond, amaranth, quinoa, or coconut proteins, or combinations thereof. In certain other embodiments, the non-dairy protein source can be algae protein or a meat protein, such as hydrolyzed chicken meat, in substitution for or in addition to the foregoing plant proteins. In some embodiments, the nutritional composition comprises up to about 7 g/100 kcal of protein source; in other embodiments, the composition includes between about 1 g and about 5 g of a protein source per 100 kcal. In certain other embodiments, the nutritional composition comprises between about 3.5 g and about 4.5 g of protein per 100 kcal. The inclusion of such non-dairy proteins can be advantageous for nutritional, taste, processing and religious reasons, in addition to management of CMA.

In addition, the protein can intact or it can be a hydrolyzed protein, especially in the case of soy, pea or rice protein. Thus, in some embodiments, the proteins of the nutritional composition are provided as intact proteins. In other embodiments, the proteins are provided as a combination of both intact proteins and hydrolyzed proteins. In certain embodiments, the proteins may be partially hydrolyzed or extensively hydrolyzed. The hydrolyzed proteins may be treated with enzymes to break down some or most of the proteins that cause adverse symptoms with the goal of reducing allergic reactions, intolerance, and sensitization. Moreover, the proteins may be hydrolyzed by any method known in the art.

The terms “protein hydrolysates” or “hydrolyzed protein” are used interchangeably herein and refer to hydrolyzed proteins, wherein the degree of hydrolysis is may be from about 1% to about 95%, or from about 30% to about 80%, or even from about 40% to about 60%. The degree of hydrolysis is the extent to which peptide bonds are broken by a hydrolysis method. The degree of protein hydrolysis for purposes of characterizing the hydrolyzed protein component of the nutritional composition is easily determined by one of ordinary skill in the formulation arts by quantifying the amino nitrogen to total nitrogen ratio (AN/TN) of the protein component of the selected formulation. The amino nitrogen component is quantified by USP titration methods for determining amino nitrogen content, while the total nitrogen component is determined by the Kjeldahl method, all of which are well known methods to one of ordinary skill in the analytical chemistry art.

When a peptide bond in a protein is broken by enzymatic hydrolysis, one amino group is released for each peptide bond broken, causing an increase in amino nitrogen. It should be noted that even non-hydrolyzed protein would contain some exposed amino groups. Hydrolyzed proteins will also have a different molecular weight distribution than the non-hydrolyzed proteins from which they were formed. The functional and nutritional properties of hydrolyzed proteins can be affected by the different size peptides. A molecular weight profile is usually given by listing the percent by weight of particular ranges of molecular weight (in Daltons) fractions (e.g., 2,000 to 5,000 Daltons, greater than 5,000 Daltons).

In some embodiments, the nutritional composition of the present disclosure is substantially free of intact proteins. The extent to which a nutritional composition in accordance with the disclosure is substantially free of intact proteins is determined by the August 2000 Policy Statement of the American Academy of Pediatrics in which a hypoallergenic formula is defined as one which in appropriate clinical studies demonstrates that it does not provoke reactions in 90% of infants or children with confirmed cow's milk allergy with 95% confidence when given in prospective randomized, double-blind, placebo-controlled trials.

In a particular embodiment, the nutritional composition also contains free amino acids as a protein equivalent source. In this embodiment, the amino acids may comprise, but are not limited to, histidine, isoleucine, leucine, lysine, methionine, cysteine, phenylalanine, tyrosine, threonine, tryptophan, valine, alanine, arginine, asparagine, aspartic acid, glutamic acid, glutamine, glycine, proline, serine, carnitine, taurine and mixtures thereof. In some embodiments, the amino acids may be branched chain amino acids. In other embodiments, small amino acid peptides may be included as the protein component of the nutritional composition. Such small amino acid peptides may be naturally occurring or synthesized. The amount of free amino acids in the nutritional composition may vary from about 1 to about 5 g/100 kcal. In an embodiment, 100% of the free amino acids have a molecular weight of less than 500 Daltons.

The nutritional composition of the present disclosure also includes at least one probiotic; in a preferred embodiment, the probiotic comprises LGG. In certain other embodiments, the probiotic may be selected from any other Lactobacillus species, Bifidobacterium species, Bifidobacterium longum BB536 (BL999, ATCC: BAA-999), Bifidobacterium longum AH1206 (NCIMB: 41382), Bifidobacterium breve AH1205 (NCIMB: 41387), Bifidobacterium infantis 35624 (NCIMB: 41003), and Bifidobacterium animalis subsp. lactis BB-12 (DSM No. 10140) or any combination thereof.

The amount of the probiotic may vary from about 1×10⁴ to about 1.5×10¹² cfu of probiotic(s) per 100 kcal. In some embodiments the amount of probiotic may be from about 1×10⁶ to about 1×10⁹ cfu of probiotic(s) per 100 kcal. In certain other embodiments the amount of probitic may vary from about 1×10⁷ cfu/100 kcal to about 1×10⁸ cfu of probiotic(s) per 100 kcal.

As noted, in a preferred embodiment, the probiotic comprises LGG. LGG is a probiotic strain isolated from healthy human intestinal flora. It was disclosed in U.S. Pat. No. 5,032,399 to Gorbach, et al., which is herein incorporated in its entirety, by reference thereto. LGG is resistant to most antibiotics, stable in the presence of acid and bile, and attaches avidly to mucosal cells of the human intestinal tract. It survives for 1-3 days in most individuals and up to 7 days in 30% of subjects. In addition to its colonization ability, LGG also beneficially affects mucosal immune responses. LGG is deposited with the depository authority American Type Culture Collection (“ATCC”) under accession number ATCC 53103.

In an embodiment, the probiotic(s) may be viable or non-viable. The probiotics useful in the present disclosure may be naturally-occurring, synthetic or developed through the genetic manipulation of organisms, whether such source is now known or later developed.

In some embodiments, the nutritional composition may include a source comprising probiotic cell equivalents, which refers to the level of non-viable, non-replicating probiotics equivalent to an equal number of viable cells. The term “non-replicating” is to be understood as the amount of non-replicating microorganisms obtained from the same amount of replicating bacteria (cfu/g), including inactivated probiotics, fragments of DNA, cell wall or cytoplasmic compounds. In other words, the quantity of non-living, non-replicating organisms is expressed in terms of cfu as if all the microorganisms were alive, regardless whether they are dead, non-replicating, inactivated, fragmented etc. In non-viable probiotics are included in the nutritional composition, the amount of the probiotic cell equivalents may vary from about 1×10⁴ to about 1.5×10¹⁰ cell equivalents of probiotic(s) per 100 kcal. In some embodiments the amount of probiotic cell equivalents may be from about 1×10⁶ to about 1×10⁹ cell equivalents of probiotic(s) per 100 kcal nutritional composition. In certain other embodiments the amount of probiotic cell equivalents may vary from about 1×10⁷ to about 1×10⁸ cell equivalents of probiotic(s) per 100 kcal of nutritional composition.

In some embodiments, the probiotic source incorporated into the nutritional composition may comprise both viable colony-forming units, and non-viable cell-equivalents.

In some embodiments, the nutritional composition includes a culture supernatant from a late-exponential growth phase of a probiotic batch-cultivation process. Without wishing to be bound by theory, it is believed that the activity of the culture supernatant can be attributed to the mixture of components (including proteinaceous materials, and possibly including (exo)polysaccharide materials) as found released into the culture medium at a late stage of the exponential (or “log”) phase of batch cultivation of the probiotic. The term “culture supernatant” as used herein, includes the mixture of components found in the culture medium. The stages recognized in batch cultivation of bacteria are known to the skilled person. These are the “lag,” the “log” (“logarithmic” or “exponential”), the “stationary” and the “death” (or “logarithmic decline”) phases. In all phases during which live bacteria are present, the bacteria metabolize nutrients from the media, and secrete (exert, release) materials into the culture medium. The composition of the secreted material at a given point in time of the growth stages is not generally predictable.

In an embodiment, a culture supernatant is obtainable by a process comprising the steps of (a) subjecting a probiotic such as LGG to cultivation in a suitable culture medium using a batch process; (b) harvesting the culture supernatant at a late exponential growth phase of the cultivation step, which phase is defined with reference to the second half of the time between the lag phase and the stationary phase of the batch-cultivation process; (c) optionally removing low molecular weight constituents from the supernatant so as to retain molecular weight constituents above 5-6 kiloDaltons (kDa); (d) removing liquid contents from the culture supernatant so as to obtain the composition.

The culture supernatant may comprise secreted materials that are harvested from a late exponential phase. The late exponential phase occurs in time after the mid exponential phase (which is halftime of the duration of the exponential phase, hence the reference to the late exponential phase as being the second half of the time between the lag phase and the stationary phase). In particular, the term “late exponential phase” is used herein with reference to the latter quarter portion of the time between the lag phase and the stationary phase of the LGG batch-cultivation process. In some embodiments, the culture supernatant is harvested at a point in time of 75% to 85% of the duration of the exponential phase, and may be harvested at about ⅚ of the time elapsed in the exponential phase.

Without being bound by any theory, it is believed the disclosed combination of non-dairy proteins and probiotic, especially LGG, provides a higher potential to bring allergic infants and children to a normal diet, fast management of CMA manifestations, to improve eczema and atopic dermatitis scores with benefits in decreasing gastrointestinal symptoms and improving recovery of the inflamed colonic mucosa, and can accelerate the development of tolerance acquisition in infants affected by CMA. In addition, it is believed that the potential exists to extend similar benefits to provide for improved tolerance acquisition for infants and children with soy protein, peanut, tree nut, wheat, corn or rice protein allergy.

The unique combination of nutrients in the disclosed nutritional composition is believed to be capable of providing novel and unexpected benefits for infants and children. Moreover, the benefit of this nutritional composition is believed to be obtained during infancy, and also by including it as part of a diverse diet as the child and its brain continues to grow and develop.

In certain embodiments, the nutritional composition of the present disclosure can also include a fat or lipid source. Suitable fat or lipid sources may be any known or used in the art, including but not limited to, animal sources, e.g., milk fat, butter, butter fat, egg yolk lipid; marine sources, such as fish oils, marine oils, single cell oils; plant and plant oils, such as corn oil, canola oil, sunflower oil, soybean oil, palm olein oil, coconut oil, high oleic sunflower oil, evening primrose oil, rapeseed oil, olive oil, flaxseed (linseed) oil, cottonseed oil, high oleic safflower oil, palm stearin, palm kernel oil, wheat germ oil; medium chain triglyceride oils and emulsions and esters of fatty acids; and any combination thereof. In one particular embodiment, the fat or lipid source comprises a mixture of palm oil, sunflower oil and safflower oil, in relatively equal parts.

In certain embodiments, the fat or lipid source provides stearidonic acid (“SDA)” and/or gamma-linolenic acid (“GLA”), by the use of SDA-enriched plant oils, especially SDA-enriched vegetable oils. Generally speaking, enrichment of a plant oil with SDA can be accomplished by any of a variety of methods, including by genetic modification of the plant-source for the oil. For instance, SDA- and GLA-enriched soybean oil, developed by Monsanto Co. with The Solae Co., is produced by the introduction of two desaturase genes that encode for the proteins, Primula juliae Δ6 desaturase and Neurospora crassa Δ15 desaturase. Soybeans lack Δ6 desaturase and the minimal requirement for production of SDA in soybeans would be the introduction of a gene encoding Δ6 desaturase. However, Δ6 desaturase also may lead to the production of GLA. Addition of a Δ15 desaturase with temporal expression similar to the Δ6 desaturase increases the flux of ALA to SDA. The Δ15 desaturase also lowers the substrate pool for GLA production.

The fat or lipid source is present in the nutritional composition in an amount up to about 7 g/100 kcal; in embodiments, the fat or lipid source is present at about 3 g/100 kcal to about 7 g/100 kcal. When supplemented with an SDA-enriched plant oil, the fat or lipid source comprises at least about 0.25 g/100 kcal, and more preferably from about 0.3 g/100 kcal to about 0.7 g/100 kcal, of a plant oil enriched with stearidonic acid, such as SDA-enriched soybean oil.

In some embodiments, the fat or lipid source comprises polar lipids, present in the nutritional composition at a level of about 0.5 mg/100 kcal to about 470 mg/100 kcal; in some embodiments, polar lipids are present at a level of about 10 mg/100 kcal to about 350 mg/100 kcal; In yet other embodiments, polar lipids are present in the nutritional composition at a level of about 20 mg/100 kcal to about 260 mg/100 kcal. In certain embodiments, the polar lipids comprise milk polar lipids.

In some embodiments, the polar lipids comprise gangliosides and phospholipids, where the gangliosides are present at a level of about 0.5 mg/100 kcal to about 18 mg/100 kcal, and the phospholipids are present at a level of about 10 mg/100 kcal to about 450 mg/100 kcal. In another embodiment, the gangliosides are present at 1 mg/100 kcal to about 9 mg/100 kcal, and the phospholipids are present at about 20 mg/100 kcal to about 250 mg/100 kcal.

The levels of gangliosides and phospholipids can be keyed to the more specific age of the subject infant or child. For instance, for an infant, the gangliosides can be present at a level of about 0.5 mg/100 kcal to about 12 mg/100 kcal, more preferably from about 1 mg/100 kcal to about 9 mg/100 kcal, and the phospholipids can be present at a level of about 20 mg/100 kcal to about 250 mg/100 kcal, more preferably about 20 mg/100 kcal to about 50 mg/100 kcal. For a child, the gangliosides can be present at a level of about 1 mg/100 kcal to about 18 mg/100 kcal, more preferably from about 1.5 mg/100 kcal to about 12 mg/100 kcal, and the phospholipids can be present at a level of about 20 mg/100 kcal to about 450 mg/100 kcal, more preferably about 20 mg/100 kcal to about 250 mg/100 kcal.

In some embodiments, the nutritional composition comprises at least one carbohydrate source. Carbohydrate sources can be any used in the art, e.g., lactose, glucose, fructose, corn syrup solids, maltodextrins, sucrose, starch, rice syrup solids, and the like. The amount of the carbohydrate component in the nutritional composition typically can vary from between about 5 g and about 25 g/100 kcal. In some embodiments, the amount of carbohydrate is between about 6 g and about 22 g/100 kcal. In other embodiments, the amount of carbohydrate is between about 12 g and about 14 g/100 kcal. In some embodiments, corn syrup solids are preferred; in other embodiments, maltodextrins are preferred. Moreover, hydrolyzed, partially hydrolyzed, and/or extensively hydrolyzed carbohydrates may be desirable for inclusion in the nutritional composition due to their easy digestibility. Specifically, hydrolyzed carbohydrates are less likely to contain allergenic epitopes.

Non-limiting examples of carbohydrate materials suitable for use herein include hydrolyzed or intact, naturally or chemically modified, starches sourced from corn, tapioca, rice or potato, in waxy or non-waxy forms. Non-limiting examples of suitable carbohydrates include various hydrolyzed starches characterized as hydrolyzed cornstarch, maltodextrin, maltose, corn syrup, dextrose, corn syrup solids, glucose, and various other glucose polymers and combinations thereof. Non-limiting examples of other suitable carbohydrates include those often referred to as sucrose, lactose, fructose, high fructose corn syrup, indigestible oligosaccharides such as fructooligosaccharides and combinations thereof.

In one particular embodiment, the carbohydrate component of the nutritional composition is comprised of 100% lactose. In another embodiment, the carbohydrate component comprises between about 0% and 60% lactose. In another embodiment, the carbohydrate component comprises between about 15% and 55% lactose. In yet another embodiment, the carbohydrate component comprises between about 20% and 30% lactose. In these embodiments, the remaining source of carbohydrates may be any carbohydrate known in the art.

The nutritional composition may also contain one or more prebiotics (also referred to as a prebiotic component) in certain embodiments. Prebiotics exert health benefits, which may include, but are not limited to, selective stimulation of the growth and/or activity of one or a limited number of beneficial gut bacteria, stimulation of the growth and/or activity of ingested probiotic microorganisms, selective reduction in gut pathogens, and favorable influence on gut short chain fatty acid profile. Such prebiotics may be naturally-occurring, synthetic, or developed through the genetic manipulation of organisms and/or plants, whether such new source is now known or developed later. Prebiotics useful in the present disclosure may include oligosaccharides, polysaccharides, and other prebiotics that contain fructose, xylose, soya, galactose, glucose and mannose.

More specifically, prebiotics useful in the present disclosure may include polydextrose, polydextrose powder, lactulose, lactosucrose, raffinose, gluco-oligosaccharide, inulin, fructo-oligosaccharide, isomalto-oligosaccharide, soybean oligosaccharides, lactosucrose, xylo-oligosaccharide, chito-oligosaccharide, manno-oligosaccharide, aribino-oligosaccharide, siallyl-oligosaccharide, fuco-oligosaccharide, galacto-oligosaccharide and gentio-oligosaccharides.

In an embodiment, the total amount of prebiotics present in the nutritional composition may be from about 1.0 g/L to about 10.0 g/L of the composition. More preferably, the total amount of prebiotics present in the nutritional composition may be from about 2.0 g/L and about 8.0 g/L of the composition. In some embodiments, the total amount of prebiotics present in the nutritional composition may be from about 0.01 g/100 kcal to about 0.15 g/100 kcal. In certain embodiments, the total amount of prebiotics present in the nutritional composition may be from about 0.03 g/100 kcal to about 0.07 g/100 kcal. Moreover, the nutritional composition may comprise a prebiotic component comprising PDX. In some embodiments, the prebiotic component comprises at least 20% w/w PDX, GOS or a mixture thereof.

If PDX is used in the prebiotic composition, the amount of PDX in the nutritional composition may, in an embodiment, be within the range of from about 0.015 g/100 kcal to about 0.15 g/100 kcal. In another embodiment, the amount of polydextrose is within the range of from about 0.02 g/100 kcal to about 0.06 g/100 kcal. In some embodiments, PDX may be included in the nutritional composition in an amount sufficient to provide between about 1.0 g/L and 10.0 g/L. In another embodiment, the nutritional composition contains an amount of PDX that is between about 2.0 g/L and 8.0 g/L. And in still other embodiments, the amount of PDX in the nutritional composition may be from about 0.015 g/100 kcal to about 0.05 g/100 kcal.

In other embodiments, the prebiotic component may comprise GOS. If GOS is used in the prebiotic composition, the amount of GOS in the nutritional composition may, in an embodiment, be from about 0.015 g/100 kcal to about 0.15 g/100 kcal. In another embodiment, the amount of GOS in the nutritional composition may be from about 0.02 g/100 kcal to about 0.05 g/100 kcal. In other embodiments, the amount of GOS in the nutritional composition may be from about 0.015 g/100 kcal to about 0.1 g/100 kcal or from about 0.01 mg/100 kcal to about 0.05 mg/100 kcal.

In a particular embodiment of the present invention, PDX is administered in combination with GOS.

In a particular embodiment, GOS and PDX are supplemented into the nutritional composition in a total amount of at least about 0.02 g/100 kcal or about 0.02 g/100 kcal to about 0.15 mg/100 kcal. In some embodiments, the nutritional composition may comprise GOS and PDX in a total amount of from about 0.06 to about 0.08 mg/100 kcal.

The nutritional composition of the disclosure can, in some embodiments, also contain a source of LCPUFAs; especially a source of LCPUFAs that comprises docosahexaenoic acid. Other suitable LCPUFAs include, but are not limited to, α-linoleic acid, γ-linoleic acid, linoleic acid, linolenic acid, eicosapentaenoic acid (EPA) and arachidonic acid (ARA).

In an embodiment, especially if the nutritional composition is an infant formula, the nutritional composition is supplemented with both DHA and ARA. In this embodiment, the weight ratio of ARA:DHA may be between about 1:3 and about 9:1. In a particular embodiment, the ratio of ARA:DHA is from about 1:2 to about 4:1.

The amount of long chain polyunsaturated fatty acid in the nutritional composition is advantageously at least about 5 mg/100 kcal, and may vary from about 5 mg/100 kcal to about 100 mg/100 kcal, more preferably from about 10 mg/100 kcal to about 50 mg/100 kcal.

The nutritional composition may be supplemented with oils containing DHA and/or ARA using standard techniques known in the art. For example, DHA and ARA may be added to the composition by replacing an equivalent amount of an oil, such as high oleic sunflower oil, normally present in the composition. As another example, the oils containing DHA and ARA may be added to the composition by replacing an equivalent amount of the rest of the overall fat blend normally present in the composition without DHA and ARA.

If utilized, the source of DHA and/or ARA may be any source known in the art such as marine oil, fish oil, single cell oil, egg yolk lipid, and brain lipid. In some embodiments, the DHA and ARA are sourced from single cell Martek oils, DHASCO® and ARASCO®, or variations thereof. The DHA and ARA can be in natural form, provided that the remainder of the LCPUFA source does not result in any substantial deleterious effect on the infant. Alternatively, the DHA and ARA can be used in refined form.

In an embodiment, sources of DHA and ARA are single cell oils as taught in U.S. Pat. Nos. 5,374,567; 5,550,156; and 5,397,591, the disclosures of which are incorporated herein in their entirety by reference. However, the present disclosure is not limited to only such oils.

While the inclusion of mammalian proteins, especially dairy proteins, is to be avoided, in some embodiments it may be desirable to include lactoferrin in the nutritional composition of the present disclosure. Lactoferrins are single chain polypeptides of about 80 kD containing 1-4 glycans, depending on the species. The 3-D structures of lactoferrin of different species are very similar, but not identical. Each lactoferrin comprises two homologous lobes, called the N- and C-lobes, referring to the N-terminal and C-terminal part of the molecule, respectively. Each lobe further consists of two sub-lobes or domains, which form a cleft where the ferric ion (Fe³⁺) is tightly bound in synergistic cooperation with a (bi)carbonate anion. These domains are called N1, N2, C1 and C2, respectively. The N-terminus of lactoferrin has strong cationic peptide regions that are responsible for a number of important binding characteristics. Lactoferrin has a very high isoelectric point (˜pl 9) and its cationic nature plays a major role in its ability to defend against bacterial, viral, and fungal pathogens. There are several clusters of cationic amino acids residues within the N-terminal region of lactoferrin mediating the biological activities of lactoferrin against a wide range of microorganisms. For instance, the N-terminal residues 1-47 of human lactoferrin (1-48 of bovine lactoferrin) are critical to the iron-independent biological activities of lactoferrin. In human lactoferrin, residues 2 to 5 (RRRR) and 28 to 31 (RKVR) are arginine-rich cationic domains in the N-terminus especially critical to the antimicrobial activities of lactoferrin. A similar region in the N-terminus is found in bovine lactoferrin (residues 17 to 42; FKCRRWQWRMKKLGAPSITCVRRAFA).

As described in “Perspectives on Interactions Between Lactoferrin and Bacteria” which appeared in the publication BIOCHEMISTRY AND CELL BIOLOGY, pp 275-281 (2006), lactoferrins from different host species may vary in their amino acid sequences though commonly possess a relatively high isoelectric point with positively charged amino acids at the end terminal region of the internal lobe. Suitable non-human lactoferrins for use in the present disclosure include, but are not limited to, those having at least 48% homology with the amino acid sequence of human lactoferrin. For instance, bovine lactoferrin (“bLF”) has an amino acid composition which has about 70% sequence homology to that of human lactoferrin. In some embodiments, the non-human lactoferrin has at least 55% homology with human lactoferrin and in some embodiments, at least 65% homology. Non-human lactoferrins acceptable for use in the present disclosure include, without limitation, bLF, porcine lactoferrin, equine lactoferrin, buffalo lactoferrin, goat lactoferrin, murine lactoferrin and camel lactoferrin.

In one embodiment, lactoferrin is present in the nutritional composition in an amount of at least about 15 mg/100 kCal. In certain embodiments, the nutritional composition may include between about 15 and about 300 mg lactoferrin per 100 kCal. In another embodiment, where the nutritional composition is an infant formula, the nutritional composition may comprise lactoferrin in an amount of from about 60 mg to about 150 mg lactoferrin per 100 kCal; in yet another embodiment, the nutritional composition may comprise about 60 mg to about 100 mg lactoferrin per 100 kCal.

In some embodiments, the nutritional composition can include lactoferrin in the quantities of from about 0.5 mg to about 1.5 mg per milliliter of formula. In nutritional compositions replacing human milk, lactoferrin may be present in quantities of from about 0.6 mg to about 1.3 mg per milliliter of formula. In certain embodiments, the nutritional composition may comprise between about 0.1 and about 2 grams lactoferrin per liter. In some embodiments, the nutritional composition includes between about 0.6 and about 1.5 grams lactoferrin per liter of formula.

The bLF that is used in certain embodiments may be any bLF isolated from whole milk and/or having a low somatic cell count, wherein “low somatic cell count” refers to a somatic cell count less than 200,000 cells/mL. By way of example, suitable bLF is available from Tatua Co-operative Dairy Co. Ltd., in Morrinsville, New Zealand, from FrieslandCampina Domo in Amersfoort, Netherlands or from Fonterra Co-Operative Group Limited in Auckland, New Zealand.

Lactoferrin for use in the present disclosure may be, for example, isolated from the milk of a non-human animal or produced by a genetically modified organism. For example, in U.S. Pat. No. 4,791,193, incorporated by reference herein in its entirety, Okonogi et al. discloses a process for producing bovine lactoferrin in high purity. Generally, the process as disclosed includes three steps. Raw milk material is first contacted with a weakly acidic cationic exchanger to absorb lactoferrin followed by the second step where washing takes place to remove nonabsorbed substances. A desorbing step follows where lactoferrin is removed to produce purified bovine lactoferrin. Other methods may include steps as described in U.S. Pat. Nos. 7,368,141, 5,849,885, 5,919,913 and 5,861,491, the disclosures of which are all incorporated by reference in their entirety.

In certain embodiments, lactoferrin utilized in the present disclosure may be provided by an expanded bed absorption (“EBA”) process for isolating proteins from milk sources. EBA, also sometimes called stabilized fluid bed adsorption, is a process for isolating a milk protein, such as lactoferrin, from a milk source comprises establishing an expanded bed adsorption column comprising a particulate matrix, applying a milk source to the matrix, and eluting the lactoferrin from the matrix with an elution buffer comprising about 0.3 to about 2.0 M sodium chloride. Any mammalian milk source may be used in the present processes, although in particular embodiments, the milk source is a bovine milk source. The milk source comprises, in some embodiments, whole milk, reduced fat milk, skim milk, whey, casein, or mixtures thereof.

In particular embodiments, the target protein is lactoferrin, though other milk proteins, such as lactoperoxidases or lactalbumins, also may be isolated. In some embodiments, the process comprises the steps of establishing an expanded bed adsorption column comprising a particulate matrix, applying a milk source to the matrix, and eluting the lactoferrin from the matrix with about 0.3 to about 2.0M sodium chloride. In other embodiments, the lactoferrin is eluted with about 0.5 to about 1.0 M sodium chloride, while in further embodiments, the lactoferrin is eluted with about 0.7 to about 0.9 M sodium chloride.

The expanded bed adsorption column can be any known in the art, such as those described in U.S. Pat. Nos. 7,812,138, 6,620,326, and 6,977,046, the disclosures of which are hereby incorporated by reference herein. In some embodiments, a milk source is applied to the column in an expanded mode, and the elution is performed in either expanded or packed mode. In particular embodiments, the elution is performed in an expanded mode. For example, the expansion ratio in the expanded mode may be about 1 to about 3, or about 1.3 to about 1.7. EBA technology is further described in international published application nos. WO 92/00799, WO 02/18237, WO 97/17132, which are hereby incorporated by reference in their entireties.

The isoelectric point of lactoferrin is approximately 8.9. Prior EBA methods of isolating lactoferrin use 200 mM sodium hydroxide as an elution buffer. Thus, the pH of the system rises to over 12, and the structure and bioactivity of lactoferrin may be comprised, by irreversible structural changes. It has now been discovered that a sodium chloride solution can be used as an elution buffer in the isolation of lactoferrin from the EBA matrix. In certain embodiments, the sodium chloride has a concentration of about 0.3 M to about 2.0 M. In other embodiments, the lactoferrin elution buffer has a sodium chloride concentration of about 0.3 M to about 1.5 M, or about 0.5 m to about 1.0 M.

In other embodiments, lactoferrin for use in the composition of the present disclosure can be isolated through the use of radial chromatography or charged membranes, as would be familiar of the skilled artisan.

In some embodiments the nutritional composition also comprises sialic acid. Sialic acids are a family of over 50 members of 9-carbon sugars, all of which are derivatives of neuroaminic acid. The predominant sialic acid family found in humans is from the N-acetylneuraminic acid sub-family. Sialic acids are found in milk, such as bovine and caprine. In mammals, neuronal cell membranes have the highest concentration of sialic acid compared to other body cell membranes. Sialic acid residues are also components of gangliosides.

If included in the nutritional composition, sialic acid may be present in an amount from about 0.5 mg/100 kcals to about 45 mg/100 kcal. In some embodiments sialic acid may be present in an amount from about 5 mg/100 kcals to about 30 mg/100 kcals. In still other embodiments, sialic acid may be present in an amount from about 10 mg/100 kcals to about 25 mg/100 kcals.

As noted, the disclosed nutritional composition may comprise a source of β-glucan. Glucans are polysaccharides, specifically polymers of glucose, which are naturally occurring and may be found in cell walls of bacteria, yeast, fungi, and plants. Beta glucans (β-glucans) are themselves a diverse subset of glucose polymers, which are made up of chains of glucose monomers linked together via beta-type glycosidic bonds to form complex carbohydrates.

β-1,3-glucans are carbohydrate polymers purified from, for example, yeast, mushroom, bacteria, algae, or cereals. (Stone B A, Clarke A E. Chemistry and Biology of (1-3)-Beta-Glucans. London: Portland Press Ltd; 1993.) The chemical structure of β-1,3-glucan depends on the source of the β-1,3-glucan. Moreover, various physiochemical parameters, such as solubility, primary structure, molecular weight, and branching, play a role in biological activities of β-1,3-glucans. (Yadomae T., Structure and biological activities of fungal beta-1,3-glucans. Yakugaku Zasshi. 2000; 120:413-431.)

β-1,3-glucans are naturally occurring polysaccharides, with or without β-1,6-glucose side chains that are found in the cell walls of a variety of plants, yeasts, fungi and bacteria. β-1,3;1,6-glucans are those containing glucose units with (1,3) links having side chains attached at the (1,6) position(s). β-1,3;1,6 glucans are a heterogeneous group of glucose polymers that share structural commonalties, including a backbone of straight chain glucose units linked by a β-1,3 bond with β-1,6-linked glucose branches extending from this backbone. While this is the basic structure for the presently described class of β-glucans, some variations may exist. For example, certain yeast β-glucans have additional regions of β(1,3) branching extending from the β(1,6) branches, which add further complexity to their respective structures.

β-glucans derived from baker's yeast, Saccharomyces cerevisiae, are made up of chains of D-glucose molecules connected at the 1 and 3 positions, having side chains of glucose attached at the 1 and 6 positions. Yeast-derived β-glucan is an insoluble, fiber-like, complex sugar having the general structure of a linear chain of glucose units with a β-1,3 backbone interspersed with β-1,6 side chains that are generally 6-8 glucose units in length. More specifically, β-glucan derived from baker's yeast is poly-(1,6)-β-D-glucopyranosyl-(1,3)-β-D-glucopyranose.

Furthermore, β-glucans are well tolerated and do not produce or cause excess gas, abdominal distension, bloating or diarrhea in pediatric subjects. Addition of β-glucan to a nutritional composition for a pediatric subject, such as an infant formula, a growing-up milk or another children's nutritional product, will improve the subject's immune response by increasing resistance against invading pathogens and therefore maintaining or improving overall health.

In some embodiments, the β-glucan is β-1,3;1,6-glucan. In some embodiments, the β-1,3;1,6-glucan is derived from baker's yeast. The nutritional composition may comprise whole glucan particle β-glucan, particulate β-glucan, PGG-glucan (poly-1,6-β-D-glucopyranosyl-1,3-β-D-glucopyranose) or any mixture thereof.

In some embodiments, the amount of β-glucan present in the composition is at between about 0.010 and about 0.080 g per 100 g of composition. In other embodiments, the nutritional composition comprises between about 10 and about 30 mg β-glucan per serving. In another embodiment, the nutritional composition comprises between about 5 and about 30 mg β-glucan per 8 fl. oz. (236.6 mL) serving. In other embodiments, the nutritional composition comprises an amount of β-glucan sufficient to provide between about 15 mg and about 90 mg β-glucan per day. The nutritional composition may be delivered in multiple doses to reach a target amount of β-glucan delivered to the subject throughout the day.

In some embodiments, the amount of β-glucan in the nutritional composition is between about 3 mg and about 17 mg per 100 kcal. In another embodiment the amount of β-glucan is between about 6 mg and about 17 mg per 100 kcal.

One or more vitamins and/or minerals may also be added in to the nutritional composition in amounts sufficient to supply the daily nutritional requirements of a subject. It is to be understood by one of ordinary skill in the art that vitamin and mineral requirements will vary, for example, based on the age of the child. For instance, an infant may have different vitamin and mineral requirements than a child between the ages of one and thirteen years. Thus, the embodiments are not intended to limit the nutritional composition to a particular age group but, rather, to provide a range of acceptable vitamin and mineral components.

The nutritional composition may optionally include, but is not limited to, one or more of the following vitamins or derivations thereof: vitamin B₁ (thiamin, thiamin pyrophosphate, TPP, thiamin triphosphate, TTP, thiamin hydrochloride, thiamin mononitrate), vitamin B₂ (riboflavin, flavin mononucleotide, FMN, flavin adenine dinucleotide, FAD, lactoflavin, ovoflavin), vitamin B₃ (niacin, nicotinic acid, nicotinamide, niacinamide, nicotinamide adenine dinucleotide, NAD, nicotinic acid mononucleotide, NicMN, pyridine-3-carboxylic acid), vitamin B₃-precursor tryptophan, vitamin B₆ (pyridoxine, pyridoxal, pyridoxamine, pyridoxine hydrochloride), pantothenic acid (pantothenate, panthenol), folate (folic acid, folacin, pteroylglutamic acid), vitamin B₁₂ (cobalamin, methylcobalamin, deoxyadenosylcobalamin, cyanocobalamin, hydroxycobalamin, adenosylcobalamin), biotin, vitamin C (ascorbic acid), vitamin A (retinol, retinyl acetate, retinyl palmitate, retinyl esters with other long-chain fatty acids, retinal, retinoic acid, retinol esters), vitamin D (calciferol, cholecalciferol, vitamin D₃, 1,25,-dihydroxyvitamin D), vitamin E (α-tocopherol, α-tocopherol acetate, α-tocopherol succinate, α-tocopherol nicotinate, α-tocopherol), vitamin K (vitamin K₁, phylloquinone, naphthoquinone, vitamin K₂, menaquinone-7, vitamin K₃, menaquinone-4, menadione, menaquinone-8, menaquinone-8H, menaquinone-9, menaquinone-9H, menaquinone-10, menaquinone-11, menaquinone-12, menaquinone-13), choline, inositol, β-carotene and any combinations thereof.

Further, the nutritional composition may optionally include, but is not limited to, one or more of the following minerals or derivations thereof: boron, calcium, calcium acetate, calcium gluconate, calcium chloride, calcium lactate, calcium phosphate, calcium sulfate, chloride, chromium, chromium chloride, chromium picolonate, copper, copper sulfate, copper gluconate, cupric sulfate, fluoride, iron, carbonyl iron, ferric iron, ferrous fumarate, ferric orthophosphate, ferrous sulfate, polysaccharide iron, iodide, iodine, magnesium, magnesium carbonate, magnesium hydroxide, magnesium oxide, magnesium stearate, magnesium sulfate, manganese, molybdenum, phosphorus, potassium, potassium phosphate, potassium iodide, potassium chloride, potassium acetate, selenium, sulfur, sodium, docusate sodium, sodium chloride, sodium selenate, sodium molybdate, zinc, zinc oxide, zinc sulfate and mixtures thereof. Non-limiting exemplary derivatives of mineral compounds include salts, alkaline salts, esters and chelates of any mineral compound.

The minerals can be added to nutritional compositions in the form of salts such as calcium phosphate, calcium glycerol phosphate, sodium citrate, potassium chloride, potassium phosphate, magnesium phosphate, ferrous sulfate, zinc sulfate, cupric sulfate, manganese sulfate, and sodium selenite. Additional vitamins and minerals can be added as known within the art.

In an embodiment, the nutritional composition may contain between about 10 and about 50% of the maximum dietary recommendation for any given country, or between about 10 and about 50% of the average dietary recommendation for a group of countries, per serving of vitamins A, C, and E, zinc, iron, iodine, selenium, and choline. In another embodiment, the children's nutritional composition may supply about 10-30% of the maximum dietary recommendation for any given country, or about 10-30% of the average dietary recommendation for a group of countries, per serving of B-vitamins. In yet another embodiment, the levels of vitamin D, calcium, magnesium, phosphorus, and potassium in the children's nutritional product may correspond with the average levels found in milk. In other embodiments, other nutrients in the children's nutritional composition may be present at about 20% of the maximum dietary recommendation for any given country, or about 20% of the average dietary recommendation for a group of countries, per serving.

The nutritional compositions of the present disclosure may optionally include one or more of the following flavoring agents, including, but not limited to, flavored extracts, volatile oils, cocoa or chocolate flavorings, peanut butter flavoring, cookie crumbs, vanilla or any commercially available flavoring. Examples of useful flavorings include, but are not limited to, pure anise extract, imitation banana extract, imitation cherry extract, chocolate extract, pure lemon extract, pure orange extract, pure peppermint extract, honey, imitation pineapple extract, imitation rum extract, imitation strawberry extract, or vanilla extract; or volatile oils, such as balm oil, bay oil, bergamot oil, cedarwood oil, cherry oil, cinnamon oil, clove oil, or peppermint oil; peanut butter, chocolate flavoring, vanilla cookie crumb, butterscotch, toffee, and mixtures thereof. The amounts of flavoring agent can vary greatly depending upon the flavoring agent used. The type and amount of flavoring agent can be selected as is known in the art.

The nutritional compositions of the present disclosure may optionally include one or more emulsifiers that may be added for stability of the final product. Examples of suitable emulsifiers include, but are not limited to, lecithin (e.g., from egg or soy), alpha lactalbumin and/or mono- and di-glycerides, and mixtures thereof. Other emulsifiers are readily apparent to the skilled artisan and selection of suitable emulsifier(s) will depend, in part, upon the formulation and final product.

The nutritional compositions of the present disclosure may optionally include one or more preservatives that may also be added to extend product shelf life. Suitable preservatives include, but are not limited to, potassium sorbate, sodium sorbate, potassium benzoate, sodium benzoate, calcium disodium EDTA, and mixtures thereof.

The nutritional compositions of the present disclosure may optionally include one or more stabilizers and/or emulsifiers. Suitable stabilizers and/or emulsifiers for use in practicing the nutritional composition of the present disclosure include, but are not limited to, gum arabic, gum ghatti, gum karaya, gum tragacanth, agar, furcellaran, guar gum, gellan gum, locust bean gum, pectin, low methoxyl pectin, gelatin, microcrystalline cellulose, CMC (sodium carboxymethylcellulose), methylcellulose hydroxypropyl methyl cellulose, hydroxypropyl cellulose, DATEM (diacetyl tartaric acid esters of mono- and diglycerides), dextran, carrageenans, CITREM (citric acid esters of mono- and diglycerides), octenyl succinic anhydride (OSA)-modified starch, citric acid esters of mono- & diglycerides, and mixtures thereof.

The disclosed nutritional composition(s) may be provided in any form known in the art, such as a powder, a gel, a suspension, a paste, a solid, a liquid, a liquid concentrate, a reconstituteable powdered milk substitute or a ready-to-use product. The nutritional composition may, in certain embodiments, comprise a nutritional supplement, children's nutritional product, infant formula, human milk fortifier, growing-up milk or any other nutritional composition designed for an infant or a pediatric subject. Nutritional compositions of the present disclosure include, for example, orally-ingestible, health-promoting substances including, for example, foods, beverages, tablets, capsules and powders. Moreover, the nutritional composition of the present disclosure may be standardized to a specific caloric content, it may be provided as a ready-to-use product, or it may be provided in a concentrated form. In some embodiments, the nutritional composition is in powder form with a particle size in the range of 5 μm to 1500 μm, more preferably in the range of 10 μm to 300 μm.

If the nutritional composition is in the form of a ready-to-use product, the osmolality of the nutritional composition may be between about 100 and about 1100 mOsm/kg water, more typically about 200 to about 700 mOsm/kg water.

The nutritional compositions of the disclosure may provide minimal, partial or total nutritional support. The compositions may be nutritional supplements or meal replacements. The compositions may, but need not, be nutritionally complete. In an embodiment, the nutritional composition of the disclosure is nutritionally complete and contains suitable types and amounts of lipid, carbohydrate, protein, vitamins and minerals. The amount of lipid or fat typically can vary from about 1 to about 7 g/100 kcal. The amount of protein typically can vary from about 1 to about 7 g/100 kcal. The amount of carbohydrate typically can vary from about 6 to about 22 g/100 kcal.

In certain embodiments, the nutritional composition comprises carotenoids, such as lutein, zeaxanthin, astaxanthin, lycopene, beta-carotene, alpha-carotene, gamma-carotene, and/or beta-cryptoxanthin. Plant sources rich in carotenoids include, but are not limited to kiwi, grapes, citrus, tomatoes, watermelons, papayas and other red fruits, or dark greens, such as kale, spinach, turnip greens, collard greens, romaine lettuce, broccoli, zucchini, garden peas and Brussels sprouts, spinach, carrots.

Humans cannot synthesize carotenoids, but over 34 carotenoids have been identified in human breast milk, including isomers and metabolites of certain carotenoids. In addition to their presence in breast milk, dietary carotenoids, such as alpha and beta-carotene, lycopene, lutein, zeaxanthin, astaxanthin, and cryptoxanthin are present in serum of lactating women and breastfed infants. Carotenoids in general have been reported to improve cell-to-cell communication, promote immune function, support healthy respiratory health, protect skin from UV light damage, and have been linked to reduced risk of certain types of cancer, and all-cause mortality. Furthermore, dietary sources of carotenoids and/or polyphenols are absorbed by human subjects, accumulated and retained in breast milk, making them available to nursing infants. Thus, addition of phytonutrients to infant formulas or children's products would bring the formulas closer in composition and functionality to human milk.

Flavonoids, as a whole, may also be included in the nutritional composition, as flavonoids cannot be synthesized by humans. Moreover, flavonoids from plant or algae extracts may be useful in the monomer, dimer and/or polymer forms. In some embodiments, the nutritional composition comprises levels of the monomeric forms of flavonoids similar to those in human milk during the first three months of lactation. Although flavonoid aglycones (monomers) have been identified in human milk samples, the conjugated forms of flavonoids and/or their metabolites may also be useful in the nutritional composition. The flavonoids could be added in the following forms: free, glucuronides, methyl glucuronides, sulphates, and methyl sulphates.

In an embodiment, the nutritional composition(s) of the present disclosure comprises an effective amount of choline. Choline is a nutrient that is essential for normal function of cells. It is a precursor for membrane phospholipids, and it accelerates the synthesis and release of acetylcholine, a neurotransmitter involved in memory storage. Moreover, though not wishing to be bound by this or any other theory, it is believed that dietary choline and docosahexaenoic acid (DHA) act synergistically to promote the biosynthesis of phosphatidylcholine and thus help promote synaptogenesis in human subjects. Additionally, choline and DHA may exhibit the synergistic effect of promoting dendritic spine formation, which is important in the maintenance of established synaptic connections. In some embodiments, the nutritional composition(s) of the present disclosure includes an effective amount of choline, which is about 20 mg choline per 8 fl. oz. (236.6 mL) serving to about 100 mg per 8 fl. oz. (236.6 mL) serving.

The present disclosure further provides a method for providing nutritional support to a subject. The method includes administering to the subject an effective amount of the nutritional composition of the present disclosure.

The nutritional composition may be expelled directly into a subject's intestinal tract. In some embodiments, the nutritional composition is expelled directly into the gut. In some embodiments, the composition may be formulated to be consumed or administered enterally under the supervision of a physician and may be intended for the specific dietary management of a disease or condition, such as celiac disease and/or food allergy, for which distinctive nutritional requirements, based on recognized scientific principles, are established by medical evaluation.

The nutritional composition of the present disclosure is not limited to compositions comprising nutrients specifically listed herein. Any nutrients may be delivered as part of the composition for the purpose of meeting nutritional needs and/or in order to optimize the nutritional status in a subject.

In some embodiments, the nutritional composition may be delivered to an infant from birth until a time that matches full-term gestation. In some embodiments, the nutritional composition may be delivered to an infant until at least about three months corrected age. In another embodiment, the nutritional composition may be delivered to a subject as long as is necessary to correct nutritional deficiencies. In yet another embodiment, the nutritional composition may be delivered to an infant from birth until at least about six months corrected age. In yet another embodiment, the nutritional composition may be delivered to an infant from birth until at least about one year corrected age.

The nutritional composition of the present disclosure may be standardized to a specific caloric content, it may be provided as a ready-to-use product, or it may be provided in a concentrated form.

In some embodiments, the nutritional composition of the present disclosure is a growing-up milk. Growing-up milks are fortified milk-based beverages intended for children over 1 year of age (typically from 1-3 years of age, from 4-6 years of age or from 1-6 years of age). They are not medical foods and are not intended as a meal replacement or a supplement to address a particular nutritional deficiency. Instead, growing-up milks are designed with the intent to serve as a complement to a diverse diet to provide additional insurance that a child achieves continual, daily intake of all essential vitamins and minerals, macronutrients plus additional functional dietary components, such as non-essential nutrients that have purported health-promoting properties.

The exact composition of a nutritional composition according to the present disclosure can vary from market-to-market, depending on local regulations and dietary intake information of the population of interest. In some embodiments, nutritional compositions according to the disclosure consist of a milk protein source, such as whole or skim milk, plus added sugar and sweeteners to achieve desired sensory properties, and added vitamins and minerals. The fat composition is typically derived from the milk raw materials. Total protein can be targeted to match that of human milk, cow milk or a lower value. Total carbohydrate is usually targeted to provide as little added sugar, such as sucrose or fructose, as possible to achieve an acceptable taste. Typically, Vitamin A, calcium and Vitamin D are added at levels to match the nutrient contribution of regional cow milk. Otherwise, in some embodiments, vitamins and minerals can be added at levels that provide approximately 20% of the dietary reference intake (DRI) or 20% of the Daily Value (DV) per serving. Moreover, nutrient values can vary between markets depending on the identified nutritional needs of the intended population, raw material contributions and regional regulations.

Examples are provided to illustrate some embodiments of the nutritional composition of the present disclosure but should not be interpreted as any limitation thereon. Other embodiments within the scope of the claims herein will be apparent to one skilled in the art from the consideration of the specification or practice of the nutritional composition or methods disclosed herein. It is intended that the specification, together with the example, be considered to be exemplary only, with the scope and spirit of the disclosure being indicated by the claims which follow the example.

### Example 1

This example illustrates an embodiment of a nutritional composition according to the present disclosure.

| Ingredient | Amount per 100 g | Unit |
|---|---|---|
| Malodextrin | 46.39 | g |
| Fat blend | 25.4 | g |
| Rice protein hydrolysate | 17 | g |
| OSA-modified starch | 5 | g |
| Calcium phosphate | 1.3 | g |
| Calcium citrate | 0.9 | g |
| Potassium citrate | 0.8 | g |
| ARA and DHA | 0.7 | g |
| Sodium citrate | 0.2 | g |
| Choline chloride | 0.2 | g |
| Potassium chloride | 0.1 | g |
| Magnesium oxide | 0.07 | g |
| Calcium hydroxide | 0.06 | g |
| L-carnitine | 0.01 | g |
| Sodium iodide | 0.1 | mg |
| Amino acid mix | 0.9 | g |
| Vitamin-taurine mix | 0.3 | g |
| Iron trituration | 0.2 | g |
| Trace/ultratrace minerals | 0.12 | g |
| LGG | 0.35 | g |

### Example 2

This example illustrates another embodiment of a nutritional composition according to the present disclosure.

| Ingredient | Amount per 100 g | Unit |
|---|---|---|
| Corn syrup solids | 52.52 | g |
| Fat blend | 25.4 | g |
| Soy protein | 15 | g |
| Calcium phosphate | 1.3 | g |
| Calcium citrate | 0.9 | g |
| Potassium citrate | 0.8 | g |
| ARA and DHA | 0.7 | g |
| Sodium citrate | 0.3 | g |
| Choline chloride | 0.2 | g |
| Potassium chloride | 0.8 | g |
| Magnesium oxide | 0.2 | g |
| L-carnitine | 0.01 | g |
| Sodium iodide | 0.1 | mg |
| Vitamin, taurine and | 1.2 | g |
| methionine mix | | |
| Iron trituration | 0.2 | g |
| Trace/ultratrace minerals | 0.12 | g |
| LGG | 0.35 | g |

### Example 3

This example illustrates yet another embodiment of a nutritional composition according to the present disclosure.

| Ingredient | Amount per 100 g | Unit |
|---|---|---|
| Corn syrup solids | 49.52 | g |
| Fat blend | 25.4 | g |
| Soy protein hydrolysate | 15 | g |
| Emulsifier | 3 | g |
| Calcium phosphate | 1.3 | g |
| Calcium citrate | 0.9 | g |
| Potassium citrate | 0.8 | g |
| ARA and DHA | 0.7 | g |
| Sodium citrate | 0.3 | g |
| Choline chloride | 0.2 | g |
| Potassium chloride | 0.8 | g |
| Magnesium oxide | 0.2 | g |
| L-carnitine | 0.01 | g |
| Sodium iodide | 0.1 | mg |
| Vitamin, taurine and | 1.2 | g |
| methionine mix | | |
| Iron trituration | 0.2 | g |
| Trace/ultratrace minerals | 0.12 | g |
| LGG | 0.35 | g |

### Example 4

This example illustrates still another embodiment of a nutritional composition according to the present disclosure.

| Ingredient | Amount per 100 g | Unit |
|---|---|---|
| Corn syrup solids | 40.21 | g |
| Fat blend | 25.1 | g |
| ARA and DHA | 0.7 | g |
| OSA-modified starch | 9 | g |
| Calcium phosphate | 1.6 | g |
| Calcium citrate | 0.4 | g |
| Calcium hydroxide | 0.15 | g |
| Choline chloride | 0.18 | g |
| Potassium chloride | 0.2 | g |
| Potassium citrate | 1.3 | g |
| Sodium citrate | 0.3 | g |
| Magnesium oxide | 0.1 | g |
| L-carnitine | 0.01 | g |
| Sodium iodide | 0.1 | mg |
| Amino acid mix | 19.6 | g |
| Vitamin mix | 0.4 | g |
| Trace/ultra trace minerals | 0.2 | g |
| Iron trituration | 0.2 | g |
| LGG | 0.35 | g |

### Example 5

This example illustrates another embodiment of a nutritional composition according to the present disclosure.

| Ingredient | Amount per 100 g | Unit |
|---|---|---|
| Corn syrup solids | 46.82 | g |
| Fat blend | 25.4 | g |
| Pea protein hydrolysate | 15 | g |
| OSA-modified starch | 6 | g |
| Calcium phosphate | 1.3 | g |
| Calcium citrate | 0.9 | g |
| Potassium citrate | 0.8 | g |
| ARA and DHA | 0.7 | g |
| Sodium citrate | 0.3 | g |
| Choline chloride | 0.2 | g |
| Potassium chloride | 0.8 | g |
| Magnesium oxide | 0.2 | g |
| L-carnitine | 0.01 | g |
| Sodium iodide | 0.1 | mg |
| Amino acid mix | 0.6 | g |
| Vitamin taurine mix | 0.3 | g |
| Iron trituration | 0.2 | g |
| Trace/ultratrace minerals | 0.12 | g |
| LGG | 0.35 | g |

### Example 6

This example illustrates still another embodiment of a nutritional composition according to the present disclosure.

| Ingredient | Amount per 100 g | Unit |
|---|---|---|
| Corn syrup solids | 44.02 | g |
| Fat blend | 25.4 | g |
| Pea/rice protein hydrolysate | 20 | g |
| Emulsifier | 4 | g |
| Calcium phosphate | 1.3 | g |
| Calcium citrate | 0.9 | g |
| Potassium citrate | 0.8 | g |
| ARA and DHA | 0.7 | g |
| Sodium citrate | 0.3 | g |
| Choline chloride | 0.2 | g |
| Potassium chloride | 0.8 | g |
| Magnesium oxide | 0.2 | g |
| L-carnitine | 0.01 | g |
| Sodium iodide | 0.1 | mg |
| Amino acid mix | 0.4 | g |
| Vitamin taurine mix | 0.3 | g |
| Iron trituration | 0.2 | g |
| Trace/ultratrace minerals | 0.12 | g |
| LGG | 0.35 | g |

### Example 7

This example illustrates another embodiment of a nutritional composition according to the present disclosure.

| Ingredient | Amount per 100 g | Unit |
|---|---|---|
| Malodextrin | 40.99 | g |
| Fat blend | 25.4 | g |
| Rice protein hydrolysate | 17 | g |
| OSA-modified starch | 5 | g |
| GOS | 3.7 | g |
| PDX | 1.7 | g |
| Calcium phosphate | 1.3 | g |
| Calcium citrate | 0.9 | g |
| Potassium citrate | 0.8 | g |
| ARA and DHA | 0.7 | g |
| Sodium citrate | 0.2 | g |
| Choline chloride | 0.2 | g |
| Potassium chloride | 0.1 | g |
| Magnesium oxide | 0.07 | g |
| Calcium hydroxide | 0.06 | g |
| L-carnitine | 0.01 | g |
| Sodium iodide | 0.1 | mg |
| Amino acid mix | 0.9 | g |
| Vitamin-taurine mix | 0.3 | g |
| Iron trituration | 0.2 | g |
| Trace/ultratrace minerals | 0.12 | g |
| LGG | 0.35 | g |

### Example 8

This example illustrates yet another embodiment of a nutritional composition according to the present disclosure.

| Ingredient | Amount per 100 g | Unit |
|---|---|---|
| Corn syrup solids | 47.12 | g |
| Fat blend | 25.4 | g |
| Soy protein | 15 | g |
| GOS | 3.7 | g |
| PDX | 1.7 | g |
| Calcium phosphate | 1.3 | g |
| Calcium citrate | 0.9 | g |
| Potassium citrate | 0.8 | g |
| ARA and DHA | 0.7 | g |
| Sodium citrate | 0.3 | g |
| Choline chloride | 0.2 | g |
| Potassium chloride | 0.8 | g |
| Magnesium oxide | 0.2 | g |
| L-carnitine | 0.01 | g |
| Sodium iodide | 0.1 | mg |
| Vitamin, taurine and | 1.2 | g |
| methionine mix | | |
| Iron trituration | 0.2 | g |
| Trace/ultratrace minerals | 0.12 | g |
| LGG | 0.35 | g |

### Example 9

This example illustrates still another embodiment of a nutritional composition according to the present disclosure.

| Ingredient | Amount per 100 g | Unit |
|---|---|---|
| Corn syrup solids | 44.12 | g |
| Fat blend | 25.4 | g |
| Soy protein hydrolysate | 15 | g |
| Emulsifier | 3 | g |
| GOS | 3.7 | g |
| PDX | 1.7 | g |
| Calcium phosphate | 1.3 | g |
| Calcium citrate | 0.9 | g |
| Potassium citrate | 0.8 | g |
| ARA and DHA | 0.7 | g |
| Sodium citrate | 0.3 | g |
| Choline chloride | 0.2 | g |
| Potassium chloride | 0.8 | g |
| Magnesium oxide | 0.2 | g |
| L-carnitine | 0.01 | g |
| Sodium iodide | 0.1 | mg |
| Vitamin, taurine and | 1.2 | g |
| methionine mix | | |
| Iron trituration | 0.2 | g |
| Trace/ultratrace minerals | 0.12 | g |
| LGG | 0.35 | g |

### Example 10

This example illustrates an embodiment of a nutritional composition according to the present disclosure.

| Ingredient | Amount per 100 g | Unit |
|---|---|---|
| Corn syrup solids | 34.81 | g |
| Fat blend | 25.1 | g |
| ARA and DHA | 0.7 | g |
| OSA-modified starch | 9 | g |
| GOS | 3.7 | g |
| PDX | 1.7 | g |
| Calcium phosphate | 1.6 | g |
| Calcium citrate | 0.4 | g |
| Calcium hydroxide | 0.15 | g |
| Choline chloride | 0.18 | g |
| Potassium chloride | 0.2 | g |
| Potassium citrate | 1.3 | g |
| Sodium citrate | 0.3 | g |
| Magnesium oxide | 0.1 | g |
| L-carnitine | 0.01 | g |
| Sodium iodide | 0.1 | mg |
| Amino acid mix | 19.6 | g |
| Vitamin mix | 0.4 | g |
| Trace/ultra trace minerals | 0.2 | g |
| Iron trituration | 0.2 | g |
| LGG | 0.35 | g |

### Example 11

This example illustrates still another embodiment of a nutritional composition according to the present disclosure.

| Ingredient | Amount per 100 g | Unit |
|---|---|---|
| Corn syrup solids | 41.42 | g |
| Fat blend | 25.4 | g |
| Pea protein hydrolysate | 15 | g |
| OSA-modified starch | 6 | g |
| GOS | 3.7 | g |
| PDX | 1.7 | g |
| Calcium phosphate | 1.3 | g |
| Calcium citrate | 0.9 | g |
| Potassium citrate | 0.8 | g |
| ARA and DHA | 0.7 | g |
| Sodium citrate | 0.3 | g |
| Choline chloride | 0.2 | g |
| Potassium chloride | 0.8 | g |
| Magnesium oxide | 0.2 | g |
| L-carnitine | 0.01 | g |
| Sodium iodide | 0.1 | mg |
| Amino acid mix | 0.6 | g |
| Vitamin taurine mix | 0.3 | g |
| Iron trituration | 0.2 | g |
| Trace/ultratrace minerals | 0.12 | g |
| LGG | 0.35 | g |

### Example 12

This example illustrates still another embodiment of a nutritional composition according to the present disclosure.

| Ingredient | Amount per 100 g | Unit |
|---|---|---|
| Corn syrup solids | 38.62 | g |
| Fat blend | 25.4 | g |
| Pea/rice protein hydrolysate | 20 | g |
| Emulsifier | 4 | g |
| GOS | 3.7 | g |
| PDX | 1.7 | g |
| Calcium phosphate | 1.3 | g |
| Calcium citrate | 0.9 | g |
| Potassium citrate | 0.8 | g |
| ARA and DHA | 0.7 | g |
| Sodium citrate | 0.3 | g |
| Choline chloride | 0.2 | g |
| Potassium chloride | 0.8 | g |
| Magnesium oxide | 0.2 | g |
| L-carnitine | 0.01 | g |
| Sodium iodide | 0.1 | mg |
| Amino acid mix | 0.4 | g |
| Vitamin taurine mix | 0.3 | g |
| Iron trituration | 0.2 | g |
| Trace/ultratrace minerals | 0.12 | g |
| LGG | 0.35 | g |

All references cited in this specification, including without limitation, all papers, publications, patents, patent applications, presentations, texts, reports, manuscripts, brochures, books, internet postings, journal articles, periodicals, and the like, are hereby incorporated by reference into this specification in their entireties. The discussion of the references herein is intended merely to summarize the assertions made by their authors and no admission is made that any reference constitutes prior art. Applicants reserve the right to challenge the accuracy and pertinence of the cited references.

Although embodiments of the disclosure have been described using specific terms, devices, and methods, such description is for illustrative purposes only. The words used are words of description rather than of limitation. It is to be understood that changes and variations may be made by those of ordinary skill in the art without departing from the spirit or the scope of the present disclosure, which is set forth in the following claims. In addition, it should be understood that aspects of the various embodiments may be interchanged in whole or in part. For example, while methods for the production of a commercially sterile liquid nutritional supplement made according to those methods have been exemplified, other uses are contemplated. Therefore, the spirit and scope of the appended claims should not be limited to the description of the versions contained therein.

What is claimed is:

1. A method for supporting and promoting nutrition in a pediatric subject having allergies to cow's milk, the method comprising administering to the pediatric subject a nutritional composition comprising:
a. up to about 7 g/100 kcal of a protein source, wherein the protein source consists essentially of one or more non-dairy proteins;
b. about 1×10⁴ to about 1.5×10¹² cfu of probiotic(s) per 100 kcal;
c. about 5 g and about 25 g/100 kcal of a carbohydrate source;
d. up to about 7 g/100 kcal of a fat or lipid source; and
e. at least about 5 mg/100 kcal of a long chain polyunsaturated fatty acid.

2. The method of claim 1, wherein the protein source is present at about 1 g/100 kcal to about 5 g/100 kcal.

3. The method of claim 1, wherein the protein source comprises a plant protein.

4. The method of claim 3, wherein the protein source comprises soy, pea, rice, potato, almond, amaranth, quinoa, or coconut protein, or combinations thereof.

5. The method of claim 4, wherein one or more of the proteins is at least partially hydrolyzed.

6. The method of claim 1, wherein the probiotic is present at about 1×10⁶ to about 1×10⁹ cfu of probiotic(s) per 100 kcal.

7. The method of claim 1, wherein the probiotic comprises Lactobacillus rhamnosus GG.

8. The method of claim 1, wherein the long chain polyunsaturated fatty acid comprises docosahexaenoic acid.

9. The method of claim 1, wherein the fat or lipid source comprises polar lipids which are present at a level of about 10 mg/100 kcal to about 350 mg/100 kcal.

10. The method of claim 1, wherein the nutritional composition is an infant formula or a growing up milk.

11. A nutritional composition for supporting and promoting nutrition in a pediatric subject having allergies to cow's milk, the nutritional composition comprising:
a. up to about 7 g/100 kcal of a protein source, wherein the protein source consists essentially of one or more non-dairy proteins;
b. about 1×10⁴ to about 1.5×10¹² cfu of probiotic(s) per 100 kcal;
c. about 5 g and about 25 g/100 kcal of a carbohydrate source;
d. up to about 7 g/100 kcal of a fat or lipid source; and
e. at least about 5 mg/100 kcal of a long chain polyunsaturated fatty acid.

12. The composition of claim 11, wherein the protein source is present at about 1 g/100 kcal to about 5 g/100 kcal.

13. The composition of claim 11, wherein the protein source comprises a plant protein.

14. The composition of claim 13, wherein the protein source comprises soy, pea, rice, potato, almond, amaranth, quinoa, or coconut protein, or combinations thereof.

15. The composition of claim 14, wherein one or more of the proteins is at least partially hydrolyzed.

16. The composition of claim 11, wherein the probiotic is present at about 1×10⁶ to about 1×10⁹ cfu of probiotic(s) per 100 kcal.

17. The composition of claim 11, wherein the probiotic comprises Lactobacillus rhamnosus GG.

18. The composition of claim 11, wherein the long chain polyunsaturated fatty acid comprises docosahexaenoic acid.

19. The composition of claim 11, wherein the fat or lipid source comprises polar lipids which are present at a level of about 10 mg/100 kcal to about 350 mg/100 kcal.

20. The composition of claim 11, wherein the nutritional composition is an infant formula or a growing up milk.
